(19) United States
(12) Patent Application Publication
(10) Pub. No.: US 2005/0219396 A1
(43) Pub. Date: Oct. 6, 2005

(54) Method and system for capturing close-up images in a cellular telephone

(76) Inventor: Richard Paul Tella, Sunnyvale, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/818,405

(22) Filed: Apr. 5, 2004

(51) Int. Cl. H04N 5/225

(52) U.S. Cl. 348/335

(57) ABSTRACT

A cellular telephone includes a camera with a close-up lens for capturing close-up images and a camera lens for capturing standard image. The close-up lens is a lens with a close focal range, for example, 6-30 centimeters. The camera lens is a lens with a standard focal range, such as, for example, a meter and beyond. A switch may be used to move a close-up lens to a position that allows the close-up lens to operate in combination with the camera lens to capture a close-up image. The switch then moves the close-up lens away from the camera lens when a standard image is captured. Alternately, a switch is used to select an image from either the close-up lens or the camera lens. The switch may be implemented, for example, as an electronic switch or an optical switch.

### BACKGROUND

A cellular telephone provides a mobile user with the ability to send and receive telephone calls. Contemporary cellular telephones also provide features and functions users can use in addition to sending and receiving telephone calls. For example, a user can access the Internet and their electronic mail, play games, and send and receive text messages. Additionally, a user can capture and send photographs using a camera integrated within the cellular telephone.

FIG. 1 is a perspective view of a cellular telephone with a camera function according to the prior art. The cellular telephone 100 includes a display 102, keypad 104 (numbers 0-9, # and *) and directional button or buttons 106. The directional buttons 106 may be use to access and/or select the various features and functions of the telephone 100. In the embodiment of FIG. 1, a picture of a dog 108 has been taken and is displayed on display 102. The picture was taken using a lens 110 located within telephone 100 (see FIG. 2).

The camera in cellular telephone 100 is typically a simple point and shoot camera. In order for lens 110 to be able to focus on the dog 108, lens 110 must be located at a certain minimum distance from the dog 108. If the lens 110 is positioned too close to the dog, the picture will be out of focus. Consequently, the camera in cellular telephone 100 cannot be used to take close-up pictures.

### SUMMARY

In accordance with the invention, a method and system for capturing close-up images in a cellular telephone are provided. A cellular telephone includes a camera having a close-up lens for capturing close-up images and a camera lens for capturing standard images. The close-up lens is a lens with a close focal range, for example, 6-30 centimeters. The camera lens is a lens with a standard focal range, such as one meter and beyond. In one embodiment in accordance with the invention, a switch is used to move a close-up lens to a position that allows the close-up lens to operate in combination with the camera lens to capture a close-up image. The switch also moves the close-up lens away from the camera lens when a standard image is captured. In other embodiments in accordance with the invention, a switch is used to select an image from either the close-up lens or the camera lens. The switch may be implemented, for example, as an electronic switch or an optical switch.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a perspective view of a cellular telephone with a camera function according to the prior art;

FIG. 2 is a perspective view of the cellular telephone of FIG. 1;

FIG. 3 is a perspective view of a close-up function in a cellular telephone in accordance with the invention;

FIG. 4 is a block diagram of a portion of a first cellular telephone in accordance with the embodiment of FIG. 3;

FIGS. 5A-5B are diagrams of a display portion of a cellular telephone and a block diagram of two lenses with a close-up switch in a first embodiment in accordance with FIG. 4;

FIG. 6 is a diagram of a display portion of a cellular telephone with a close-up function icon and a block diagram of two lenses with a close-up actuator in a second embodiment in accordance with FIG. 4;

FIG. 7 is a block diagram of a portion of a second cellular telephone in accordance with the embodiment of FIG. 3;

FIG. 8 is a block diagram of a portion of a third cellular telephone in accordance with the embodiment of FIG. 3;

FIG. 9 is a flowchart of a method for capturing images in accordance with the embodiments of FIG. 4, FIG. 7, and FIG. 8;

FIG. 10 is a perspective view of a first cellular telephone in accordance with the embodiments of FIG. 7 and FIG. 8; and

FIG. 11 is a perspective view of a second cellular telephone in accordance with the embodiments of FIG. 7 and FIG. 8.

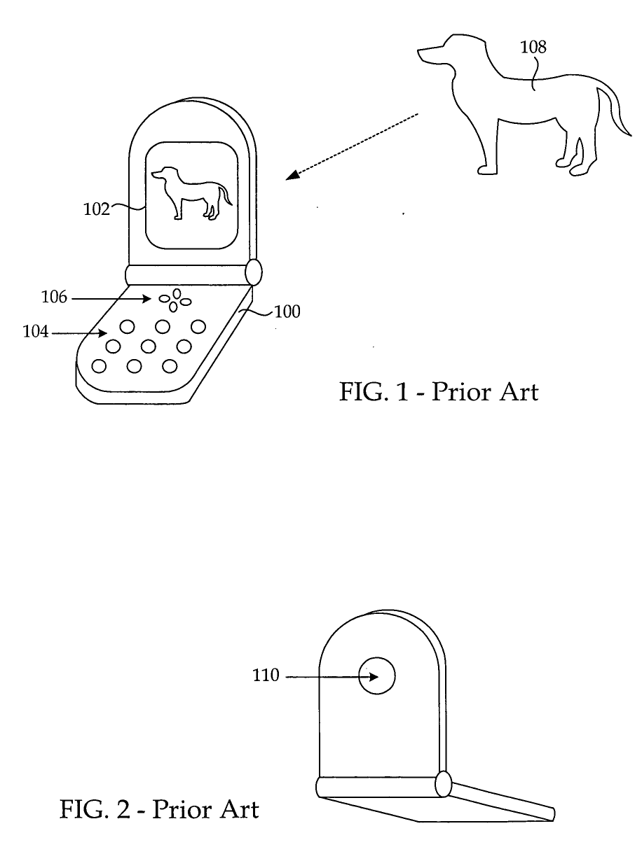

### DETAILED DESCRIPTION

The invention relates to a method and system for capturing close-up images in a cellular telephone. The following description is presented to enable one skilled in the art to make and use the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

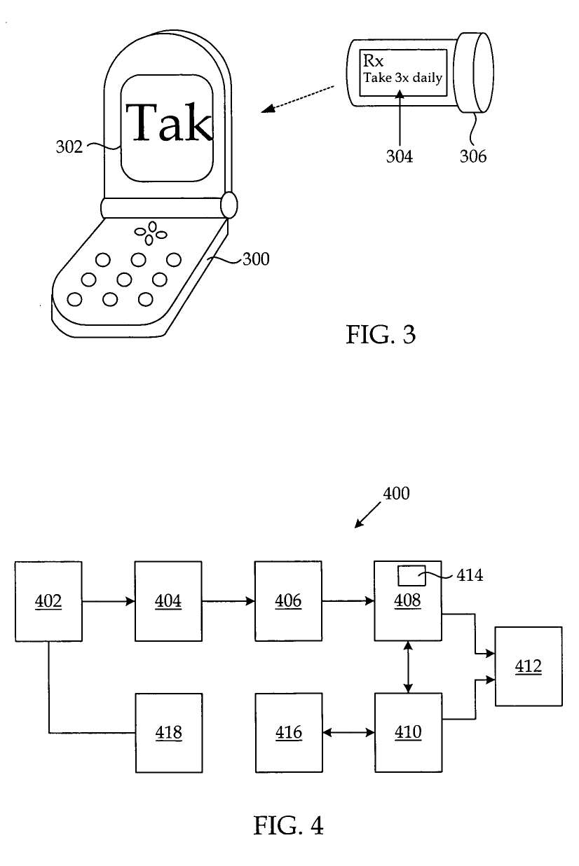

With reference now to the figures and in particular with reference to FIG. 3, there is shown a perspective view of a close-up function in a cellular telephone in accordance with the invention. A cellular telephone 300 is displaying on its screen 302 a close-up view of a prescription 304 on a bottle 306. A camera lens with a close-up or macro function (not shown) captures the image of the prescription 304 in this embodiment. The macro function allows the lens to focus on prescription 304 when bottle 306 is positioned close to the lens. A lens with a macro function is typically able to focus on an object located, for example, 6-30 centimeters from the lens.

The image of prescription 304 may be a still picture or a video (i.e., moving) image. If it is a video image, a user can move the lens over bottle 306 and read prescription 304 using the close-up function. Video images may be obtained by having the camera capture a certain number of images each second. The images are then displayed on the display 302 at the same, or nearly the same, rate.

FIG. 4 is a block diagram of a portion of a first cellular telephone in accordance with the embodiment of FIG. 3. Cellular telephone 400 includes a close-up lens 402, a camera lens 404, an image sensor 406, image processing hardware 408 and software 410, and a display 412. Image sensor 406 receives light from camera lens 404 and converts the light to a signal. The signal may be a digital or an analog signal.

In this embodiment in accordance with the invention, image sensor 406 is implemented as a complementary metal oxide semiconductor (CMOS) device and close-up lens 402 as a macro attachment lens, respectively. A macro attachment lens is a lens capable of focusing on an object located close to the lens, for example, 6-30 centimeters from the lens. In other embodiments in accordance with the invention, image sensor 406 may be implemented as other image sensing devices, such as, for example, a charge-coupled device (CCD).

Image processing hardware 408 and software 410 allow cellular telephone 400 to display a video or a still image. Image processing hardware 408 and software 410 also provide image processing functions such as, for example, electronic grab, zoom, panning, and cropping functions for video and still images.

Image processing hardware 408 may also include a memory 414 for temporarily storing an image, or portions of an image, during processing. Another memory 416 may store one or more images captured by the camera and close-up functions in the cellular phone. When a close-up image is to be captured, switch 418 moves close-up lens 402 to a position that allows close-up lens 402 to work in combination with camera lens 404 and capture a close-up image. For example, close-up lens 402 may be positioned in front of or behind camera lens 404. Alternatively, close-up lens 402 may be positioned between two of the elements of camera lens 404. When a standard image (i.e., not a close-up image) is to be captured, switch 418 moves close-up lens 402 away from camera lens 404.

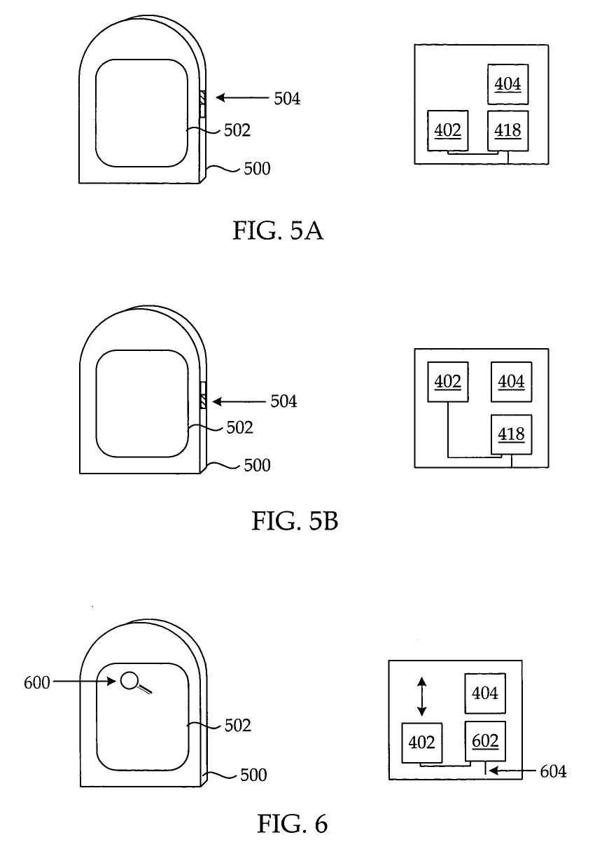

Referring now to FIGS. 5A and 5B, there are shown diagrams of a display portion of a cellular telephone and a block diagram of two lenses with a close-up switch in a first embodiment in accordance with FIG. 4. Display portion 500 includes a display 502 and a button 504. When button 504 is in the standard position (i.e., not close-up position) (see FIG. 5A), close-up lens 402 is not in a position to work in combination with camera lens 404. Thus, the camera is not able to capture close-up images with the switch in the standard position. When button 504 is placed in the close-up position (see FIG. 5B), switch 418 moves close-up lens 402 to a position that allows close-up lens 402 to work in combination with camera lens 404 and capture close-up images.

Switch 418 is a mechanical switch in this embodiment in accordance with the invention. For example, switch 418 may be implemented as a lever attached to close-up lens 402 and button 504. When button 504 is pushed down, as shown in FIG. 5B, the lever pushes close-up lens 402 up so that it is in front of lens 404. In other embodiments in accordance with the invention, the lever positions close-up lens 402 behind camera lens 404 or between two of the elements of camera lens 404. When button 504 is pushed up (see FIG. 5A), the lever pulls close-up lens 402 down so that close-up lens 402 does not operate in combination with camera lens 404.

FIG. 6 is a diagram of a display portion of a cellular telephone with a close-up function icon and a block diagram of two lenses with a close-up actuator in a second embodiment in accordance with FIG. 4. Display portion 500 includes a display 502 and an icon 600 shown on display 502. When icon 600 is activated, a signal is sent to actuator 602 via signal line 604. The signal causes actuator 602 to move close-up lens 402 to a position where close-up lens 402 operates in combination with camera lens 404. A user can activate icon 600, for example, by pressing one of the buttons on the keypad (not shown). Actuator 602 moves close-up lens 402 away from lens 404 when a user disengages the close-up function. For example, a user may use one of the buttons on the keypad (not shown) to disengage the close-up function.

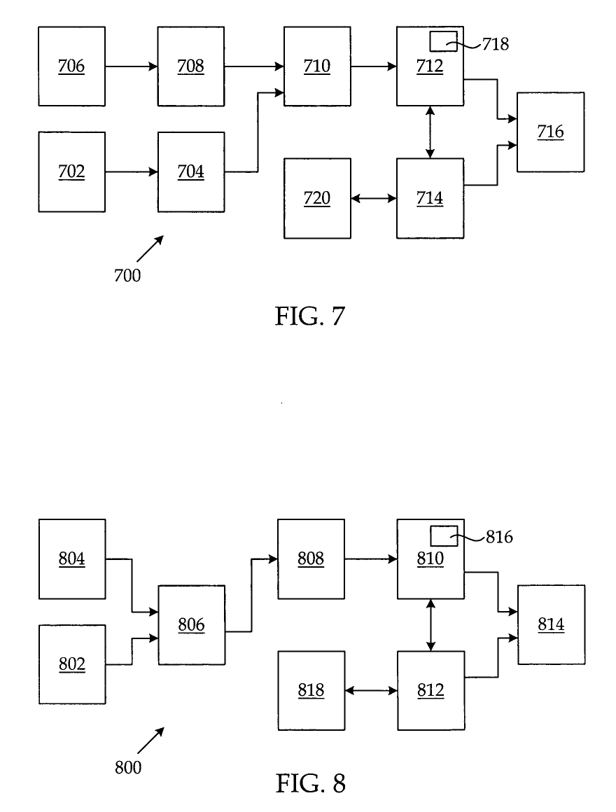

Referring now to FIG. 7, there is shown a block diagram of a portion of a second cellular telephone in accordance with the embodiment of FIG. 3. Cellular telephone 700 includes a close-up lens 702 positioned to form an image on image sensor 704, a standard lens 706 positioned to form an image on image sensor 708, a switch 710, image processing hardware 712 and software 714, and a display 716.

Close-up lens 702 is implemented in this embodiment as a camera lens with a focal range that is close to the lens, such as, for example, 6-30 centimeters. And standard lens 706 is implemented as a camera lens with a standard focal range, such as, for example, a meter and beyond. Both close-up lens 702 and standard lens 706 are fixed in position, i.e., stationary in the FIG. 7 embodiment.

Switch 710 is an electronic switch in this embodiment in accordance with the invention. Switch 710 is used to select one of the two signals received from image sensors 706, 708. Switch 710 may be implemented, for example, as an electrical switch or a multiplexer.

Image processing hardware 712 may also include a memory 718 for temporarily storing an image, or portions of an image, during processing. Another memory 720 may store one or more images captured by the camera and close-up functions in the cellular phone. Image processing hardware 712 and software 714 allow cellular telephone 700 to display video and still images and provide image processing functions such as, for example, electronic grab, zoom, panning, and cropping functions.

FIG. 8 is a block diagram of a portion of a third cellular telephone in accordance with the embodiment of FIG. 3. Cellular telephone 800 includes a close-up lens 802 and a standard lens 804 connected to switch 806, an image sensor 808, image processing hardware 810 and software 812, and a display 814.

Close-up lens 802 is implemented in this embodiment as a camera lens with a focal range that is close to the lens, such as, for example, 6-30 centimeters. And standard lens 804 is implemented as a camera lens with a standard focal range, such as, for example, a meter and beyond. Both close-up lens 802 and standard lens 804 are fixed in position (i.e., stationary in the FIG. 8 embodiment.

Switch 806 is an optical switch in this embodiment in accordance with the invention. Switch 806 selects light from one of the lenses 802, 804 and transmits the light to image sensor 808. Switch 806 may be implemented, for example, as a prism, a translatable mirror, or a rotatable mirror.

Image processing hardware 810 may also include a memory 816 for temporarily storing an image, or portions of an image, during processing. Another memory 818 may store one or more images captured by the camera and close-up functions in the cellular phone. Image processing hardware 810 and software 812 allow cellular telephone 800 to display a video and still images and provide image processing functions such as, for example, electronic grab, zoom, panning, and cropping functions.

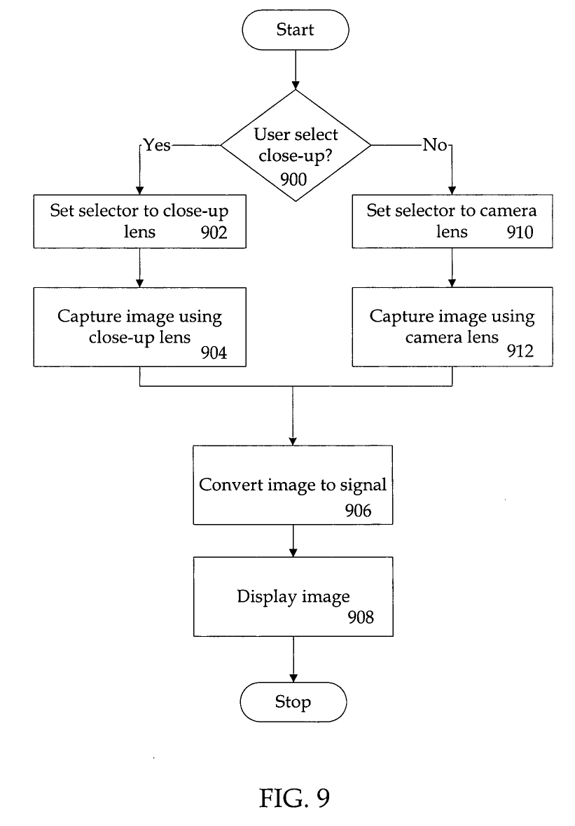

Referring now to FIG. 9, there is shown a flowchart of a method for capturing images in accordance with the embodiments of FIG. 4, FIG. 7, and FIG. 8. Initially a determination is made at block 900 as to whether a user has selected the close-up function. If the user has selected the close-up function, the process passes to block 902 where a selector is set to select the close-up lens. A close-up image is then captured using the close-up lens, as shown in block 904. Light in the image is converted to a signal at block 906 and the close-up image displayed on the display in the cellular telephone (block 908).

Returning to block 900, if the user has not selected the close-up function, the process passes to block 910 where a selector is set to select the standard lens. The image is then captured using the standard lens (block 912) and the process continues through blocks 906 and 908.

Blocks 902 and 904 may be performed in reverse order. In this alternate embodiment, block 904 is performed prior to the performance of block 902. Similarly, block 912 may be performed before block 910.

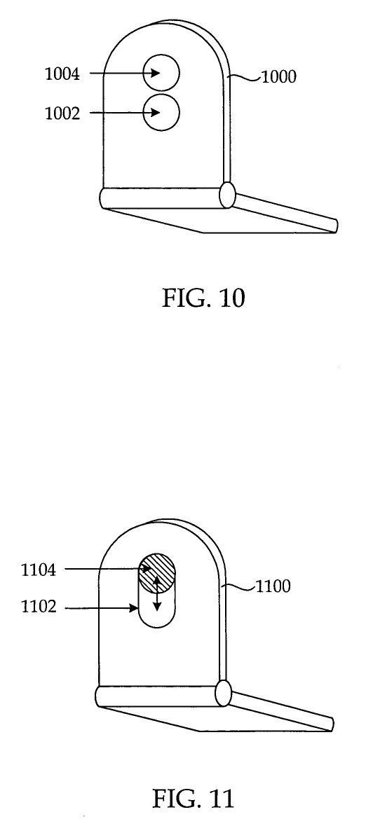

FIG. 10 is a perspective view of a first cellular telephone in accordance with the embodiments of FIG. 7 and FIG. 8. Cellular telephone 1000 includes a camera (not shown) having a close-up lens and a camera or standard lens. Opening 1002 is associated with the close-up lens and opening 1004 with the camera lens. A user selects which lens is used to capture one or more images using one of the techniques described above.

Referring to FIG. 11, there is shown a perspective view of a second cellular telephone in accordance with the embodiments of FIG. 7 and FIG. 8. Like the FIG. 10 embodiment, cellular telephone 1100 includes a camera having a close-up lens and a camera or standard lens. An opening 1102 is associated with both lenses, and a movable cover 1104 is used to select the close-up lens or the camera lens.

1. A cellular telephone, comprising:
a camera lens;
a close-up lens; and
a selector operable to select the close-up lens when a close-up image is to be captured and operable to select the camera lens when a standard image is to be captured.

2. The cellular telephone of claim 1, further comprising memory operable to store one or more captured images.

3. The cellular telephone of claim 1, wherein the selector comprises a mechanical switch connected to the close-up lens and operable to position the close-up lens so the close-up lens operates in combination with the camera lens when a close-up image is to be captured and operable to position the close-up lens away from the camera lens when a standard image is to be captured

4. The cellular telephone of claim 3, further comprising an image sensor positioned to receive light from the camera lens and operable to convert the light to a signal.

5. The cellular telephone of claim 4, wherein the signal comprises one of a digital signal and an analog signal.

6. The cellular telephone of claim 4, further comprising a display connected to receive the signal and in response thereto to display a close-up image when the close-up lens operates in combination with the camera lens and to display a standard image when the close-up lens is positioned away from the camera lens.

7. The cellular telephone of claim 1, wherein the camera lens and the close-up lens comprise a stationary camera lens and a stationary close-up lens.

8. The cellular telephone of claim 7, further comprising a first image sensor positioned to receive light from the camera lens and operable to convert the light to a first signal and a second image sensor positioned to receive light from the close-up lens and operable to convert the light to a second signal.

9. The cellular telephone of claim 8, wherein the selector comprises an electronic switch connected to an output of the first image sensor and an output of the second image sensor and operable to select the first signal when a standard image is to be captured and operable to select the second signal when a close-up image is to be captured.

10. The cellular telephone of claim 9, further comprising a display connected to receive the first signal and in response thereto to display the standard image when the first signal is selected and connected to receive the second signal and in response thereto to display the close-up image when the second signal is selected.

11. The cellular telephone of claim 7, wherein the selector comprises an optical switch positioned to receive light from the camera lens and the close-up lens and operable to select the light from the close-up lens when a close-up image is to be captured and operable to select the light from the camera lens when a standard image is to be captured.

12. The cellular telephone of claim 11, further comprising an image sensor positioned to receive light from an output of the optical switch and operable to convert the light to a signal.

13. The cellular telephone of claim 12, further comprising a display connected to receive the signal and in response thereto to display a close-up image when the light from the close-up lens is selected and to display a standard image when the light from the camera lens is selected.

14. The cellular telephone of claim 1, wherein the close-up lens comprises a camera lens operable to focus on an object positioned less than one meter from the lens.

15. A method for capturing images in a cellular telephone comprising a camera lens and a close-up lens, the method comprising:
setting a selector to a first position when a close-up image is to be captured by the close-up lens;
setting the selector to a second position when a standard image is to be captured by the camera lens;
capturing an image; and
displaying the close-up image when the selector is in the first position and displaying the standard image when the selector is in the second position.

16. The method of claim 15, wherein setting the selector comprises positioning the close-up lens so the close-up lens operates in combination with the camera lens when a close-up image is captured and positioning the close-up lens away from the camera lens when a standard image is captured.

17. The method of claim 15, wherein setting the selector comprises:
generating a first signal from light captured by the close-up lens when a close-up image is captured and generating a second signal from light captured by the camera lens when a standard image is captured; and
selecting the first signal when a close-up image is captured and selecting the second signal when a standard image is captured.

18. The method of claim 15, wherein setting the selector comprises:
selecting light from the close-up lens when a close-up image is captured and selecting light from the camera lens when a standard image is captured; and
generating a signal corresponding to the captured light.
